(19) United States
(12) Patent Application Publication
(10) Pub. No.: US 2021/0394081 A1
(43) Pub. Date: Dec. 23, 2021

(54) THERMALLY IMPACTING FLUID AND SAMPLE SEPARATION UNIT INDEPENDENTLY

(71) Applicant: Agilent Technologies, Inc., Santa Clara, CA (US)

(72) Inventors: Jose-Angel Mora, Ettlingen (DE); Uwe Effelsberg, Karlsruhe (DE); Lena Höninger, Karlsruhe (DE)

(21) Appl. No.: 17/351,084

(22) Filed: Jun. 17, 2021

(30) Foreign Application Priority Data
Jun. 18, 2020 (GB) 2009290.4

(51) Int. Cl. B01D 15/16; G01N 30/30; B01D 15/12

(52) U.S. Cl. CPC B01D 15/161; G01N 30/30; G01N 2030/3046; G01N 2030/303; B01D 15/12

(57) ABSTRACT

A thermal impact assembly for a sample separation apparatus for separating a fluidic sample in a mobile phase by a sample separation unit includes a thermal impact device configured for thermally impacting the fluidic sample and/or the mobile phase and the sample separation unit, and a control unit configured for controlling the thermal impact device for thermally impacting the fluidic sample and/or the mobile phase on the one hand and for thermally impacting the sample separation unit on the other hand independently from each other.

### RELATED APPLICATIONS

This application claims priority to UK Application No. GB 2009290.4, filed Jun. 18, 2020, the entire contents of which are incorporated herein by reference.

### TECHNICAL FIELD

The present invention relates to a thermal impact assembly, to a sample separation apparatus, and to a process of adjusting a temperature of a fluidic sample and/or a mobile phase and of a sample separation unit in a sample separation apparatus.

### BACKGROUND

In liquid chromatography, a fluid (such as a mixture between a fluidic sample and a mobile phase) may be pumped through conduits and a column comprising a material (stationary phase) which is capable of separating different components of the fluidic sample. Such a material, so-called beads which may comprise silica gel, may be filled into a column which may be connected to other elements (like a sampling unit, a flow cell, containers including sample and/or buffers) by conduits.

For operating a sample separation apparatus, the fluid can be pre-heated by a pre-heater assembly located downstream of an injector for injecting the fluidic sample in the mobile phase and upstream of the column.

US 2015/0196855 A1 discloses an arrangement for mounting components in a heating chamber for heating a fluid of a fluid separation apparatus, wherein the arrangement comprises a mounting board having at least one mounting recess each configured for accommodating at least one component, and the at least one component each configured to be mountable in and/or on the at least one mounting recess.

WO 2010/025777 A1 discloses an apparatus for deriving an operation mode from a first fluidic device to a second fluidic device, wherein the first fluidic device has a first target operation mode representing a desired behavior of the first fluidic device and has a first real operation mode representing the actual behavior of the first fluidic device, wherein the second fluidic device has a second target operation mode representing a desired behavior of the second fluidic device and has a second real operation mode representing the actual behavior of the second fluidic device, the apparatus comprising a first determining unit adapted for determining the first real operation mode based on the first target operation mode and based on a preknown parameterization of the first fluidic device, and a second determining unit adapted for determining the second target operation mode based on the determined first real operation mode and based on a preknown parameterization of the second fluidic device.

US 2009/0076631 A1 discloses an apparatus for determining an operation mode of a device, wherein the device is capable of adjusting a physical condition at a source position to correspondingly influence a physical condition at a destination position, the apparatus comprising a determining unit adapted for determining the operation mode by defining a time dependency of the physical condition at the source position so that a target time-dependency of the physical condition is obtained for the destination position, the target time-dependency representing a resultant variation of the physical condition over time.

### SUMMARY

It is an object of the invention to enable operation of a sample separation apparatus for separating a fluidic sample in a mobile phase in a flexible way.

According to an exemplary embodiment of the present invention, a thermal impact assembly for a sample separation apparatus is provided, wherein the thermal impact assembly comprises a thermal impact device configured for thermally impacting a fluidic sample to be separated, and/or for thermally impacting a mobile phase by or in which the fluidic sample may be transported, and for thermally impacting the sample separation unit, and a control unit configured for controlling the thermal impact device for thermally impacting the fluidic sample and/or the mobile phase on the one hand and for thermally impacting the sample separation unit on the other hand independently from each other.

According to another exemplary embodiment of the present invention, a sample separation apparatus for separating a fluidic sample is provided, wherein the sample separation apparatus comprises a fluid drive unit configured for driving a mobile phase and the fluidic sample injected in the mobile phase, a sample separation unit configured for separating the fluidic sample in the mobile phase, and a thermal impact assembly having the above mentioned features for thermally impacting the fluidic sample and/or the mobile phase on the one hand and the sample separation unit on the other hand independently from each other.

According to still another exemplary embodiment, a process of adjusting a temperature of a fluidic sample and/or a mobile phase and of a sample separation unit in a sample separation apparatus is provided, wherein the process comprises thermally influencing the fluidic sample and/or the mobile phase and the sample separation unit, and controlling the thermally influencing so as to thermally influence the fluidic sample and/or the mobile phase on the one hand and to thermally influence the sample separation unit on the other hand independently from each other.

In the context of this application, the term “sample separation apparatus” may particularly denote any apparatus which is capable of separating different fractions of a fluidic sample by applying a certain separation technique, in particular liquid chromatography.

In the context of this application, the term “fluidic sample” may particularly denote any liquid and/or gaseous medium, optionally including also solid particles, which is to be analyzed. Such a fluidic sample may comprise a plurality of fractions of molecules or particles which shall be separated, for instance small mass molecules or large mass biomolecules such as proteins. Separation of a fluidic sample into fractions may involve a certain separation criterion (such as mass, volume, chemical properties, etc.) according to which a separation is carried out.

In the context of this application, the term “mobile phase” may particularly denote any liquid and/or gaseous medium which may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample which have previously been adsorbed to a stationary phase of a sample separation unit.

In the context of the present application, the term “fluid drive unit” may particularly denote an entity capable of driving a fluid (i.e. a liquid and/or a gas, optionally comprising solid particles), in particular the fluidic sample and/or the mobile phase. For instance, the fluid drive may be a pump (for instance embodied as piston pump or peristaltic pump) or another source of high pressure. For instance, the fluid drive may be a high-pressure pump, for example capable of driving a fluid with a pressure of at least 100 bar, in particular at least 500 bar.

The term “sample separation unit” may particularly denote a fluidic member through which a fluidic sample is transferred, and which is configured so that, upon conducting the fluidic sample through the separation unit, the fluidic sample will be separated into different groups of molecules or particles. An example for a separation unit is a liquid chromatography column which is capable of trapping or retarding and selectively releasing different fractions of the fluidic sample.

The term “thermal impact assembly” may particularly denote an arrangement being configured for thermally impacting or tempering a fluid (in form of a fluidic sample and/or a mobile phase) and a sample separation unit. Thermally impacting, thermally influencing or thermally manipulating may mean influencing the temperature, in particular in a controlled or even regulated way. In particular, thermally impacting may be accomplished by heating (i.e. by supplying thermal energy) and/or by cooling (i.e. by removing thermal energy).

The term “thermal impact device” may particularly denote a device which may be appropriately controlled for thermally impacting a fluid and a sample separation unit, respectively. Such a thermal impact device may include multiple thermal impact units, each separately controlled by a control unit and each capable of heating or cooling a respectively assigned destination. The destination may for instance be a fluid (in particular a fluidic sample or a mobile phase), which may be heated for instance while flowing through a conduit or while being surrounded by a pre-heater assembly. The destination may also be a sample separation unit which may be heated or cooled directly, for instance while being arranged in a compartment.

The term “controlling for thermally impacting independently” may particularly denote that a process for a controlled thermal impact on fluidic sample and/or mobile phase may be carried out without the need that this process is mandatorily limited or influenced by another process for a controlled thermal impact on a sample separation unit. A control of the one thermal impact can thus be made regardless of a control of the other thermal impact. While the results of the mentioned processes of controlled tempering may have a certain impact on each other due to a thermal interaction between a mobile phase and/or a fluidic sample flowing through a sample separation unit, an external adjustment of the two thermally impacting processes may be made separately or independently from each other, for instance using different control signals for the two thermally impacting processes. Thus, there may be an independency on the control side.

According to an exemplary embodiment, temperature control of a mobile phase and/or a fluidic sample on the one hand and temperature control of a sample separation unit for separating the fluidic sample on the other hand may be decoupled from each other on a control side. By taking this measure, an additional degree of freedom or an additional design parameter may be provided in comparison with a scenario in which pre-heating of fluidic sample, mobile phase and a sample separation unit is carried out by one common control process controlling all mentioned elements in the same way. According to an exemplary embodiment, the functional separation or independent configuration of thermally impacting fluids on the one hand and thermally impacting a sample separation unit on the other hand, on a control side, may allow refining or rendering more accurate pre-heating (or more generally: thermally conditioning) in terms of sample separation. Moreover, the independent adjustability of fluid temperature and the temperature of the sample separation unit may be a highly appropriate basis for transferring a separation method developed for a conventional sample separation apparatus to another sample separation apparatus according to an exemplary embodiment of the invention. Operation parameters for the independent temperature adjustment of fluid and sample separation unit may be adjusted so that the sample separation apparatus according to an exemplary embodiment can be flexibly configured and re-configured to behave like many different conventional sample separation apparatuses in terms of temperature management. This may enable operation of the sample separation apparatus according to an exemplary embodiment of the invention for separating a fluidic sample in a mobile phase in a highly flexible way.

In the following, further embodiments of the thermal impact assembly, the sample separation apparatus, and the process will be explained.

In an embodiment, the thermal impact device comprises a first thermal impact unit (which may be operable independently of a below mentioned second thermal impact unit) configured for thermally impacting the fluidic sample and/or the mobile phase and comprises a second thermal impact unit (which may be operable independently of the first thermal impact unit) configured for thermally impacting the sample separation unit. The thermal impact units may be operable independently from each other. The two structurally separate thermal impact units may form a proper hardware basis for functionally independently carrying out a temperature adjustment of fluid and sample separation unit separately. It is also possible that at least one third thermal impact unit is provided, in order to further refine tempering and/or for further increasing the degree of freedom for emulating a separation behavior of another conventional sample separation apparatus by a sample separation apparatus according to an exemplary embodiment of the invention.

In an embodiment, the first thermal impact unit is thermally decoupled from the second thermal impact unit. Such a thermal decoupling may be obtained for instance by sandwiching thermally insulating material between the first thermal impact unit and the second thermal impact unit. The mentioned thermal decoupling may promote a functional decoupling between pre-heating of fluid and pre-heating of a sample separation unit prior to a sample separation process.

In an embodiment, the control unit is configured for controlling the first thermal impact unit and the second thermal impact unit separately. In particular, this may be achieved by supplying different and independent control signals from the control unit to the first thermal impact unit on the one hand and to the second thermal impact unit on the other hand.

In an embodiment, the fluidic sample and/or the mobile phase is arranged to be tempered by the first thermal impact unit and additionally by the second thermal impact unit. In particular, the fluidic sample and/or the mobile phase may be arranged to be tempered directly by the first thermal impact unit and indirectly by the second thermal impact unit. For example, the fluidic sample and/or the mobile phase may be arranged to be heated by the second thermal impact unit (for instance a heated heating plate or other bulk body) and selectively further heated or cooled by the first thermal impact unit (for instance embodied as Peltier unit). For example, the sample separation unit can then be arranged to be tempered by the second thermal impact unit only. Such an embodiment is shown for instance in FIG. 7. In such a configuration, it is for instance possible that a majority of the thermal energy provided for thermally impacting or influencing both the fluids and the sample separation unit is provided by a sufficiently powerful second thermal impact unit heating the sample separation unit directly and the fluids indirectly via the first thermal impact unit. The first thermal impact unit may then be used for refining the temperature control of the fluids, i.e. can be configured small and accurate.

Alternatively, it is also possible that the fluids are thermally impacted or conditioned (in particular heated) directly by one thermal impact unit only, whereas the sample separation unit may be tempered by both the first thermal impact unit and the second thermal impact unit.

In an embodiment, the first thermal impact unit is arranged partially or entirely upstream (in a flowing direction of the mobile phase and the fluidic sample) of the second thermal impact unit. In other words, preheating of the fluids may be carried out before the fluids reach the sample separation unit.

In an embodiment, the first thermal impact unit and the second thermal impact unit are arranged in a spatially overlapping manner. Alternatively, the first thermal impact unit may be arranged completely within (i.e. in an interior of) the second thermal impact unit. In both configurations is for instance possible that the second thermal impact unit may heat the entire sample separation unit(s), whereas the first thermal impact unit thermally controls only a portion (preferably a head portion) of the sample separation unit(s).

In an embodiment, at least one of the first thermal impact unit and the second thermal impact unit comprises at least one of the group consisting of a heatable or coolable bulk body (such as a heating plate), a Peltier element and a plasma heater. Heating or cooling a bulk body may be realized for example by a cooling liquid (such as cold water) or a heating liquid (such as hot water). Heating a bulk body may also be accomplished by ohmic heating, i.e. by applying electric current which heats the bulk body by ohmic losses. A Peltier element may be a thermoelectric cooler comprising different semiconductors in contact with each other, wherein applying an electric current results in a heating or—when the current direction is inverted—in a cooling. A plasma heater may for instance be an electric arc heater which may be a low-temperature plasma generator in which an arc discharge is used as a heat release element. Plasma heating may also be used in a manufacturing process of ohmic heaters, since it allows to deploy a sandwich structure of a mix of dielectric and conductive layers in for example planar structures (such as metal micro fluidic structures), achieving high density of energy in small spaces.

In an embodiment, the second thermal impact unit is configured for thermally impacting the sample separation unit without gas convection impacting the sample separation unit by a direct gas flow directed onto the sample separation unit. Avoiding such a gas flow directly influencing the sample separation unit may improve the separation performance, in particular the chromatographic separation performance, of the sample separation unit(s). On the one hand, gas flow or gas convection is a powerful mechanism for promoting thermal exchange. On the other hand, it has turned out that the direct application of a gas flow to a sample separation unit (such as a chromatographic separation column) in terms of heating may result in a pronounced temperature profile over the radial extension of the sample separation unit. This may deteriorate the separation performance. It has been found that excellent results in terms of pre-heating and separation performance may be achieved by indirectly using gas convection for promoting thermal exchange while protecting the sample separation unit from a direct impact of the gas convection.

In an embodiment, the second thermal impact unit is configured for thermally impacting the sample separation unit with gas convection acting only indirectly on the sample separation unit. For example, this may be accomplished by providing a convection mechanism for creating the gas convection for promoting thermal coupling of the sample separation unit, and an at least partially thermally conductive shielding structure shielding or mechanically spacing the gas convection from the sample separation unit. The air flow being mechanically decoupled from but thermally coupled with the sample separation unit may provide improved temperature stability, enhanced ambient rejection and fast thermal equilibration while simultaneously achieving a high separation performance. Descriptively speaking, the gas convection acting on the sample separation unit only indirectly may promote the thermal coupling and increase the thermal homogeneity of the sample separation unit during operation. Optionally but advantageously, the at least partially thermally conductive shielding structure comprises a heat exchanger configured for promoting heat exchange between the gas convection and the sample separation unit. For instance, the heat exchanger may also function as heat source (i.e. may supply heat for heating) or heat sink (i.e. may remove heat for cooling). In such an embodiment, the one or more sample separation units may be surrounded partially or entirely by the shielding structure shielding gas convection from directly impacting the sample separation unit(s). At the same time, gas convection around an exterior surface of the shielding structure (and preferably inside of a thermal impact compartment or chamber, such as a column oven) may promote thermal exchange also inside of the shielding structure and may thus have a positive impact on the thermal controllability of the sample separation unit(s). In an embodiment, an actual heating or cooling source may form part of the heat exchanger.

In an embodiment, the control unit is configured for controlling the thermal impact device so that operation of the sample separation apparatus emulates operation of another sample separation apparatus. In particular, such an emulation can be carried out in terms of thermally impacting the fluidic sample and/or the mobile phase and in terms of thermally impacting the sample separation unit. Highly advantageously, the additional degree of freedom or the increased number of design parameters in form of the two (rather than one) tempering entities may allow to adjust the tempering parameters so that the thermal impact assembly of the sample separation apparatus according to an exemplary embodiment of the invention behaves like a thermal impact assembly of a conventional or another sample separation apparatus, when carrying out a separation method.

In an embodiment, emulation of tempering behavior of another sample separation apparatus may be combined with emulation of the other sample separation apparatus concerning at least one further aspect, in particular emulation concerning a time dependence of a solvent composition of the mobile phase during sample separation. For example, a behavior of the other sample separation apparatus can be emulated by the sample separation apparatus according to an exemplary embodiment of the invention concerning a gradient profile during a gradient run.

In an embodiment, the control unit is configured for emulating operation of the other sample separation apparatus based on a transfer function determined (for instance by the control unit) so that the sample separation apparatus behaves, in particular in terms of thermally impacting the fluidic sample and/or the mobile phase and in terms of thermally impacting the sample separation unit, like the other sample separation apparatus when carrying out a separation method developed for the other sample separation apparatus on the sample separation apparatus. In the context of the present application, the term “separation method” may particularly denote an instruction for a sample separation apparatus as to how to separate a fluidic sample, which is to be carried out by the sample separation apparatus in order to fulfill a separation task associated with the separation method. Such a separation method can be defined by a set of parameter values (for example temperature, pressure, characteristic of a solvent composition, etc.) and hardware components of the sample separation apparatus (for example the type of separation column used) and an algorithm with processes that are executed when the separation method is performed. A corresponding set of technical parameters for operating the sample separation apparatus during sample separation may be pre-known, for instance stored in a database or memory accessible by a control unit controlling operation of the sample separation apparatus. Physical properties or operation parameters characterizing a separation method may involve a transport characteristic which may include parameters such as volumes, dimensions, values of physical parameters such as pressure or temperature, and/or physical effects such as a model of friction occurring in a fluidic conduit which friction effects may be modeled, for example, according to the Hagen Poiseuille law. More particularly, the parameterization may consider dimensions of a sample separation apparatus (for instance a dimension of a fluidic channel), a volume of a fluid conduit (such as a dead volume) of the sample separation apparatus, a pump performance (such as the pump power and/or pump capacity) of the sample separation apparatus, a delay parameter (such as a delay time after switching on a sample separation apparatus) of operating the sample separation apparatus, a friction parameter (for instance characterizing friction between a wall of a fluidic conduit and a fluid flowing through the conduit) of operating the sample separation apparatus, a flush performance (particularly properties related to rinsing or flushing the sample separation apparatus before operating it or between two subsequent operations) of the sample separation apparatus, and/or a cooperation of different components of the sample separation apparatus (for instance the properties of a gradient applied to a chromatographic column). By calculating such a transfer function which may be applied for transferring a separation method developed for the conventional sample separation apparatus for use by the sample separation apparatus according to an exemplary embodiment of the invention, a numerically simple way of transferring a separation method from one sample separation apparatus to another one can be accomplished.

In an embodiment, the sample separation apparatus comprises a thermal impact compartment in which the at least one sample separation unit is arranged. Such a thermal impact compartment may be a column oven used for pre-heating the fluids and the sample separation unit(s) in preparation of a sample separation.

In an embodiment, the above-mentioned first thermal impact unit configured for thermally impacting the fluidic sample and/or the mobile phase is located upstream of the thermal impact compartment. When the second thermal impact unit is arranged inside of the thermal impact compartment, the described geometric configuration may further contribute to a proper functional separation between the first thermal impact unit and the second thermal impact unit.

In an embodiment, the sample separation apparatus comprises at least one further sample separation unit connected in parallel to the aforementioned sample separation unit and comprises a fluidic selection valve configured for selecting one of the sample separation units. Preferably, the first thermal impact unit may be integrated in the selection valve. This configuration is highly compact since it allows thermally impacting the fluids before splitting them in multiple paths, each comprising one of the sample separation units. At the same time, this configuration may ensure that the pre-heating occurs spatially close to the location of the sample separation unit used for separating the fluidic sample.

In an embodiment, the first thermal impact unit is configured as a Metal-Micro-Fluidic structure, in particular being integrated in the selection valve. In particular, a Metal-Micro-Fluidic (MMF) heater may be advantageously integrated into the fluidic selection valve, which may also be denoted as channel selection valve. Microfluidics concerns the behavior of liquids and gases in small dimensions, which can differ significantly from the behavior of macroscopic fluids, because effects can dominate on this scale, which can be neglected in macroscopic dimensions. The mentioned fluidic selection valve can be produced on the basis of metal structures, which can be produced by thermal bonding at high pressure and high temperature from stainless steel foils. Thus, heating or cooling the channel selection valve may be carried out to accomplish valve temperature control. In particular, a pre-column liquid conditioner (in particular a heater and/or a cooler) may be provided which may be embedded in a column selection valve. In other words, an integration of a heating and/or cooling capability into a selection valve may be carried out.

In an embodiment, the first thermal impact unit is arranged between the selection valve and the thermal impact compartment. This may allow to pre-heat the fluids very close to the location of separation in the sample separation unit.

In an embodiment, the first thermal impact unit is arranged upstream of the selection valve. Selecting a desired sample separation unit may then be carried out with already pre-heated fluid.

In an embodiment, a first thermal impact unit configured for thermally impacting the fluidic sample and/or the mobile phase is arranged at least partially inside of the thermal impact compartment, in particular thermally coupled to a head portion of the sample separation unit. A head portion of a sample separation unit may be a portion thereof at which the mobile phase and the fluidic sample enter the sample separation unit during a separation run. This configuration allows proper pre-heating of the fluidic sample and/or the mobile phase specifically at the separation position. Thus, no pronounced undesired cooling of pre-heated sample due to temperature equilibration phenomena may occur in such an embodiment.

In an embodiment, the sample separation apparatus comprises a thermal pre-treating assembly for thermally pre-treating (in particular for pre-heating) the fluidic sample and/or the mobile phase upstream of the sample separation unit, wherein a first thermal impact unit configured for thermally impacting the fluidic sample and/or the mobile phase is thermally coupled with the pre-treating assembly. A pre-treating assembly may be a thermally conductive structure surrounding a conduit carrying the fluids for promoting homogeneous heating of the fluids by the first thermal impact unit. Descriptively speaking, the first thermal impact unit may supply or remove thermal energy which is distributed by the pre-treating assembly along the fluid-carrying conduit.

In an embodiment, a second thermal impact unit configured for thermally impacting the sample separation unit is arranged at least partially inside of the thermal impact compartment. The second thermal impact unit may be arranged downstream of the first thermal impact unit.

In an embodiment, the fluidic sample and/or the mobile phase may be tempered by adjusting, in particular regulating, a temperature of the fluidic sample and/or the mobile phase. Correspondingly, it may be possible to thermally influence the sample separation unit by adjusting, in particular regulating, a temperature of the sample separation unit. Hence, the thermal impact units may be configured for bringing the fluids and the sample separation unit to a respective target temperature.

The sample separation unit may be filled with a separating material. Such a separating material which may also be denoted as a stationary phase may be any material which allows an adjustable degree of interaction with a fluidic sample so as to be capable of separating different components of such a fluidic sample. The separating material may be a liquid chromatography column filling material or packing material comprising at least one of the group consisting of polystyrene, zeolite, polyvinylalcohol, polytetrafluorethylene, glass, polymeric powder, silicon dioxide, and silica gel, or any of above with chemically modified (coated, capped etc.) surface. However, any packing material can be used which has material properties allowing an analyte passing through this material to be separated into different components, for instance due to different kinds of interactions or affinities between the packing material and fractions of the analyte.

At least a part of the sample separation unit may be filled with a fluid separating material, wherein the fluid separating material may comprise beads having a size in the range of essentially 1 μm to essentially 50 μm. Thus, these beads may be small particles which may be filled inside the separation section of the microfluidic device. The beads may have pores having a size in the range of essentially 0.01 μm to essentially 0.2 μm. The fluidic sample may be passed through the pores, wherein an interaction may occur between the fluidic sample and the pores.

The sample separation unit may be a chromatographic column for separating components of the fluidic sample. Therefore, exemplary embodiments may be particularly implemented in the context of a liquid chromatography apparatus.

The fluid separation system may be configured to conduct a liquid mobile phase through the separation unit. As an alternative to a liquid mobile phase, a gaseous mobile phase or a mobile phase including solid particles may be processed using the fluid separation system. Also materials being mixtures of different phases (solid, liquid, gaseous) may be processed using exemplary embodiments. The sample separation apparatus, in particular its fluid drive unit, may be configured to conduct the mobile phase through the system with a high pressure, particularly of at least 600 bar, more particularly of at least 1200 bar.

The sample separation apparatus may be configured as a microfluidic device. The term “microfluidic device” may particularly denote a sample separation apparatus as described herein which allows to convey fluid through microchannels having a dimension in the order of magnitude of less than 500 μm, particularly less than 200 μm, more particularly less than 100 μm or less than 50 μm or less.

Exemplary embodiments may be implemented with a sample injector of a liquid chromatography apparatus which sample injector may take up a fluidic sample from a fluid container and may inject such a fluidic sample in a conduit for supply to a separation column. During this procedure, the fluidic sample may be compressed from, for instance, normal pressure to a higher pressure of, for instance several hundred bars or even 1000 bar and more. An autosampler may automatically inject a fluidic sample from the vial into a sample loop. A tip or needle of the autosampler may dip into a fluid container, may suck fluid into the capillary and may then drive back into a seat to then, for instance via a switchable fluidic valve, inject the fluidic sample towards a sample separation section of the liquid chromatography apparatus.

The sample separation apparatus may be configured to analyze at least one physical, chemical and/or biological parameter of at least one component of the fluidic sample in the mobile phase. The term “physical parameter” may particularly denote a size or a temperature of the fluid. The term “chemical parameter” may particularly denote a concentration of a fraction of the analyte, an affinity parameter, or the like. The term “biological parameter” may particularly denote a concentration of a protein, a gene or the like in a biochemical solution, a biological activity of a component, etc.

The sample separation apparatus may be implemented in various technical environments, like a sensor device, a test device, a device for chemical, biological and/or pharmaceutical analysis, a capillary electrophoresis device, a liquid chromatography device, a gas chromatography device, an electronic measurement device, or a mass spectroscopy device. Particularly, the sample separation apparatus may be a High Performance Liquid Chromatography (H PLC) device by which different fractions of an analyte may be separated, examined and analyzed.

An embodiment of the present invention comprises a sample separation apparatus configured for separating compounds of a fluidic sample in a mobile phase. The sample separation apparatus comprises a mobile phase drive, such as a pumping system, configured to drive the mobile phase through the sample separation apparatus. A sample separation unit, which can be a chromatographic column, is provided for separating compounds of the sample fluid in the mobile phase. The sample separation apparatus may further comprise a sample injector configured to introduce the fluidic sample into the mobile phase, a detector configured to detect separated compounds of the fluidic sample, a collector configured to collect separated compounds of the fluidic sample, a control unit or data processing unit configured to process data received from the sample separation apparatus, and/or a degassing apparatus for degassing the mobile phase.

In the context of this application, the term “control unit” may particularly denote an electronic processor-based control unit (or system controller, data processing unit, etc.) that is, or is part of, a computing device that includes one or more electronics-based processors, memories, user interfaces for input and/or output, and the like as appreciated by persons skilled in the art. Embodiments of the invention can be partly or entirely embodied or supported by one or more suitable software programs or routines (e.g., computer-executable or machine-executable instructions or code), which can be stored on or otherwise provided by any kind of non-transitory medium or data carrier, and which might be executed in or by any suitable control unit. For example, an embodiment of the present disclosure provides a non-transitory computer-readable medium that includes instructions stored thereon, such that when executed by a processor, the instructions perform and/or control the steps of the method of any of the embodiments disclosed herein.

Embodiments of the present invention might be embodied based on most conventionally available HPLC systems, such as the Agilent 1290 Series Infinity system, Agilent 1200 Series Rapid Resolution LC system, or the Agilent 1100 HPLC series (all provided by the applicant Agilent Technologies—see the website www.agilent.com).

One embodiment comprises a pumping apparatus having a piston for reciprocation in a pump working chamber to compress liquid in the pump working chamber to a high pressure at which compressibility of the liquid becomes noticeable. One embodiment comprises two pumping apparatuses coupled either in a serial (e.g. as disclosed in EP 309596 A1) or parallel manner.

The mobile phase (or eluent) can be either a pure solvent or a mixture of different solvents. It can be chosen e.g. to minimize the retention of the compounds of interest and/or the amount of mobile phase to run the chromatography. The mobile phase can also be chosen so that the different compounds can be separated effectively. The mobile phase may comprise an organic solvent like methanol or acetonitrile, often diluted with water. For gradient operation water and organic solvent are delivered in separate bottles, from which the gradient pump delivers a programmed blend to the system. Other commonly used solvents may be isopropanol, tetrahydrofuran (THF), hexane, ethanol and/or any combination thereof or any combination of these with aforementioned solvents.

The fluidic sample may comprise any type of process liquid, natural sample like juice, body fluids like plasma or it may be the result of a reaction like from a fermentation broth.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

### BRIEF DESCRIPTION OF DRAWINGS

Other objects and many of the attendant advantages of embodiments of the present invention will be readily appreciated and become better understood by reference to the following more detailed description of embodiments in connection with the accompanying drawings. Features that are substantially or functionally equal or similar will be referred to by the same reference signs.

FIG. 1 shows a sample separation apparatus in accordance with embodiments of the present invention, particularly used in high performance liquid chromatography (HPLC), wherein thermally impacting a fluidic sample in a mobile phase is performed independently of thermally impacting a sample separation unit for separating the fluidic sample.

FIG. 2 is a schematic illustration of a thermal impact assembly for a sample separation apparatus according to an exemplary embodiment, wherein a first thermal impact unit is integrated in a selection valve and a second thermal impact unit is arranged in an interior of a thermal impact compartment.

FIG. 3 is a schematic illustration of a thermal impact assembly for a sample separation apparatus according to an exemplary embodiment, wherein a first thermal impact unit is arranged in a head portion of sample separation units and a second thermal impact unit is arranged in an interior of a thermal impact compartment.

FIG. 4 is a schematic illustration of a thermal impact assembly for a sample separation apparatus according to an exemplary embodiment, wherein a first thermal impact unit is arranged between a selection valve and a thermal impact compartment and a second thermal impact unit is arranged in an interior of the thermal impact compartment.

FIG. 5 is a schematic illustration of a thermal impact assembly for a sample separation apparatus according to an exemplary embodiment, wherein a first thermal impact unit is arranged upstream of a selection valve and a second thermal impact unit is arranged in an interior of a thermal impact compartment.

FIG. 6 is a schematic illustration of a thermal impact assembly for a sample separation apparatus according to an exemplary embodiment, wherein a first thermal impact unit is arranged in an interior of a thermal impact compartment and a second thermal impact unit is arranged in the interior of the thermal impact compartment as well, but downstream of the first thermal impact unit.

FIG. 7 is a schematic illustration of a thermal impact assembly for a sample separation apparatus according to an exemplary embodiment, wherein a first thermal impact unit for thermally impacting only a fluidic sample and/or a mobile phase in a pre-theater assembly and a second thermal impact unit for thermally impacting the fluidic sample and/or the mobile phase and for thermally impacting a sample separation unit in a thermal impact compartment are provided.

FIG. 8 is a schematic illustration of part of a thermal impact assembly in a heating compartment of a sample separation apparatus according to an exemplary embodiment, wherein sample separation units are heated by an only indirectly operating convection mechanism.

FIG. 9 is a schematic illustration of a thermal impact assembly of a sample separation apparatus according to an exemplary embodiment, wherein operation of the thermal impact assembly emulates a tempering behavior of another sample separation apparatus.

FIG. 10 is a three-dimensional view of a thermal impact unit (or part thereof) for a thermal impact assembly of a sample separation apparatus according to an exemplary embodiment, wherein the thermal impact unit is configured as a Metal-Micro-Fluidic structure for heating or cooling a mobile phase and/or a fluidic sample and being provided to be integrated in a channel selection valve.

The illustration in the drawing is schematic.

### DETAILED DESCRIPTION

Before, referring to the figures, exemplary embodiments will be explained in further detail, some basic considerations will be explained based on which exemplary embodiments have been developed.

According to an exemplary embodiment of the invention, a thermal impact assembly (such as a sample-in-mobile-phase and separation column preheater) for a sample separation apparatus (such as a liquid chromatography apparatus) is provided which enables a separate tempering (in particular temperature control or temperature adjustment) of a fluidic sample to be separated and/or a mobile phase for carrying the fluidic sample on the one hand and a sample separation unit (such as a chromatographic separation column) on the other hand. In other words, preheating sample/mobile phase may be accomplished independently of preheating the sample separation unit for separating the sample. A gist of an exemplary embodiment is thus to use independent heating sources for heating the mobile phase (which may be performed in a preheater) on the one hand and for heating the separation column on the other hand.

Conventionally, a preheater and a separation column may be tempered together, for instance via a common heat block and by implementing one or more heat exchangers. According to an exemplary embodiment, separation of heating sources for the mobile phase and the sample with respect to the sample separation unit may be advantageous. In particular, it may be advantageous that by separating the heating sources other column-oven types (or more generally other thermal impact compartments) can be emulated or simulated. By this active concept with two thermally impacting sources it may thus become possible to simulate another column oven with a passive concept with only one heating source. Descriptively speaking, the functional and logic separation between mobile phase tempering and tempering of the sample separation unit in a sample separation apparatus provides an additional degree of freedom which may be used as design parameter for emulating the operation of another sample separation apparatus by enabling thermally impacting mobile phase/fluidic sample and sample separation unit(s) independently from each other. For instance, operation of the independently adjustable tempering mechanisms of the sample separation apparatus according to an exemplary embodiment of the invention may be set for mimicking, emulating or simulating the functionality of another sample separation apparatus in terms of preheating.

In an advantageous embodiment, a thermal impact compartment (which may also be denoted as a column compartment) for thermally impacting one or more sample separation units may be conditioned by two independently controlled thermal impact units (which may be heaters and/or coolers), one dedicated to condition the liquid temperature of the fluidic sample and/or the mobile phase, and the other to condition the temperature inside the thermal impact compartment (and thereby adjusting the temperature of the one or more sample separation units in the thermal impact compartment).

When designing column compartments according to an exemplary embodiment of the invention, it may be advantageous to achieve reproducible operation conditions for the column(s), keeping backwards compatibility with existing separation methods run in other instruments (for instance legacy instruments). Keeping backwards compatibility may have an impact on the improvement of the performance of new models. Conventionally, it may be a shortcoming that when separation methods developed for one sample separation apparatus run on another sample separation apparatus may not show the same performance under the same operation conditions (such as flow rate and/or temperature of mobile phase and fluidic sample, gradient relating to varying solvent composition of mobile phase, etc.) in the new sample separation apparatus. In order to overcome such shortcomings, an exemplary embodiment of the invention may use two independently controlled thermal impact units (such as heaters and/or coolers) for conditioning a thermal impact compartment (in particular a chromatographic column compartment). In such a scenario, one thermal impact unit may be dedicated to condition the liquid temperature of mobile phase and/or fluidic sample, the other thermal impact unit may be provided to condition the temperature inside the thermal impact compartment. Advantageously, such an embodiment may ensure backwards compatibility and may improve the separation performance.

Hence, the independent or separate control of thermally impacting of mobile phase and fluidic sample on the one hand and one or more sample separation units of the sample separation apparatus on the other hand may render the sample separation apparatus backwards compatible and adjustable to legacy separation methods. Furthermore, taking this measure may allow to design sample separation apparatuses achieving significant improvement in terms of performance. Moreover, the use of an independent thermal impact unit (which may involve an independently controllable heating and/or cooling unit) for liquid (i.e. mobile phase and fluidic sample) may reduce the number of pre-column heaters to one reducing the hardware effort. The provision of a separate or independent thermal impact unit for mobile phase and fluidic sample may thus increase flexibility of operation. For instance, it may be possible to integrate such an independently controllable thermal impact unit (i.e. a pre-column heater and/or cooler) into a selection valve, for example using one or more Peltier coolers and/or one or more plasma heaters. Such a selection valve may be configured for selecting one of a plurality of parallel connected sample separation units, for instance in accordance with the requirements of a specific application. Since such a selection valve may be arranged directly upstream of the sample separation units and thus directly upstream of a thermal impact compartment, the independent control or adjustment of the temperature of the mobile phase and the fluidic sample may be spatially very close to an adjustment of the temperature of the sample separation units in the thermal impact compartment. Consequently, undesired temperature equilibrium processes may be kept small without compromising on the independent adjustability of the tempering characteristics of fluid and sample separation units.

Hence, an exemplary embodiment of the invention may make it possible to thermally condition the liquid before it gets inside the thermal impact compartment with the sample separation unit(s) which may avoid condensation issues and temperature instabilities inside.

An exemplary embodiment of the invention may introduce a first thermal impact unit (which may be a heater and/or cooler) that brings the temperature of the liquid (i.e. mobile phase and fluidic sample) to a set point. A second thermal impact unit (which may be a heater and/or a cooler as well) may be provided to control the temperature of the thermal impact compartment (including the one or more sample separation units) independently, for instance with a control logic to achieve the best performance of the separation, as a separate degree of freedom which may be used for developing a separation method. Furthermore, this may make it possible to make the thermal impact compartment backwards compatible to legacy sample separation methods and/or to legacy sample separation apparatuses. For example, a pre-column conditioner in form of the independently controllable first thermal impact unit can be located inside or outside of the section where the one or more chromatographic separation columns are allocated and where thermally impacting by a second thermal impact unit may occur.

A further aspect of an exemplary embodiment of the invention is an HPLC column oven having a hybrid configuration in terms of gas convection, i.e. a hybrid configuration with and without air circulation. In particular, a column compartment may be provided which is conditioned by an airflow conducted around the column area. In conventional HPLC column compartments either no active air flow is provided at all (leading to a more adiabatic environment), or the compartment may be provided with forced air flow (leading to a more isothermal environment). In contrast to such approaches, a column compartment according to an exemplary embodiment of the invention may be provided with a forced air flow around the area where the columns are positioned, while a forced air flow at the location of the columns itself may be reliably prevented, for instance by shielding. It has turned out that a compartment with low (i.e. no forced) air flow around the column may allow to obtain better chromatographic results. A forced, fast air flow may result in better temperature stability, better suppression of ambient phenomena and faster equilibration. According to exemplary embodiments of the invention, a forced air flow may be directed around—but preferably not up to—the column location by a flow diverter shield. The area around the columns may have significantly reduced air flow due to smaller temperature differences. This may result in higher temperature stability, may reduce the need for thick isolation and may retain good chromatographic results.

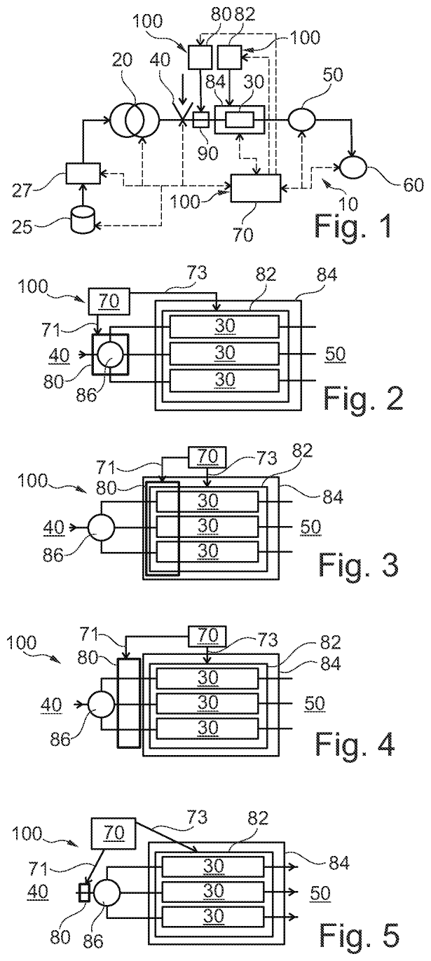

Referring now in greater detail to the drawings, FIG. 1 depicts a general schematic of a liquid separation system as an example for a sample separation apparatus 10 according to an exemplary embodiment of the invention. This embodiment includes performing thermally impacting of a fluidic sample in a mobile phase independently of thermally impacting a sample separation unit 30 for separating the fluidic sample, as will be described below in further detail.

A pump or fluid drive unit 20 receives a mobile phase from a solvent supply 25, typically via a degasser 27, which degases and thus reduces the amount of dissolved gases in the mobile phase. The fluid drive unit 20 drives the mobile phase through a sample separation unit 30 (such as a chromatographic column) comprising a stationary phase. A sampling unit or injector 40 can be provided between the fluid drive unit 20 and the sample separation unit 30 in order to subject or add (often referred to as sample introduction) a sample fluid or fluidic sample into the mobile phase. The stationary phase of the sample separation unit 30 is configured for separating compounds of the sample liquid. A detector 50 is provided for detecting separated compounds of the sample fluid. A fractionating unit 60 can be provided for outputting separated compounds of sample fluid. It is also possible that separated compounds of sample fluid as well as mobile phase are conveyed into a waste line (not shown).

While the mobile phase can be comprised of one solvent only, it may also be mixed from plural solvents. Such mixing might be a low pressure mixing and provided upstream of the fluid drive unit 20, so that the fluid drive unit 20 already receives and pumps the mixed solvents as the mobile phase. Alternatively, the fluid drive unit 20 may be composed of plural individual pumping units, with plural of the pumping units each receiving and pumping a different solvent or mixture, so that the mixing of the mobile phase (as received by the sample separation unit 30) occurs at high pressure and downstream of the fluid drive unit 20 (or as part thereof). The composition (mixture) of the mobile phase may be kept constant over time, the so called isocratic mode, or varied over time, the so called gradient mode.

A data processing unit or control unit 70, which can be a personal computer or workstation, may be coupled (as indicated by the dotted arrows) to one or more of the devices in the sample separation apparatus 10 in order to receive information and/or control operation. For example, the control unit 70 may control operation of the fluid drive unit 20 (e.g. setting control parameters) and receive therefrom information regarding the actual working conditions (such as output pressure, flow rate, etc. at an outlet of the pump 20). The control unit 70 may also control operation of the solvent supply 25 (e.g. setting the solvent/s or solvent mixture to be supplied) and/or the degasser 27 (e.g. setting control parameters such as vacuum level) and may receive therefrom information regarding the actual working conditions (such as solvent composition supplied over time, flow rate, vacuum level, etc.). The control unit 70 may further control operation of the sampling unit or injector 40 (e.g. controlling sample injection or synchronization of sample injection with operating conditions of the fluid drive unit 20). The sample separation unit 30 may also be controlled by the control unit 70 (e.g. selecting a specific flow path or column, setting operation temperature, etc.), and send—in return—information (e.g. operating conditions) to the control unit 70. Accordingly, the detector 50 may be controlled by the control unit 70 (e.g. with respect to spectral or wavelength settings, setting time constants, start/stop data acquisition), and send information (e.g. about the detected sample compounds) to the control unit 70. The control unit 70 may also control operation of the fractionating unit 60 (e.g. in conjunction with data received from the detector 50) and provide data back.

Moreover, a thermal impact assembly 100 is arranged in the sample separation apparatus 10 downstream of the injector 40 and upstream of the detector 50. The thermal impact assembly 100 is configured to adjust the temperature of the mobile phase and the fluidic sample as well as to adjust—independently or separately thereof—the temperature of the sample separation unit 30. The thermal impact assembly 100 comprises a thermal impact device, which is here composed of a controllable first thermal impact unit 80 and an independently controllable second thermal impact unit 82. Control of each of the thermal impact units 80, 82 may be carried out by control unit 70 which supplies individual and different control signals to the thermal impact units 80, 82. The first thermal impact unit 80 is configured for thermally impacting the fluidic sample and/or the mobile phase flowing through a conduit surrounded in a thermally conductive way by a pre-treating assembly 90. The second thermal impact unit 82 is configured for thermally impacting a thermal impact compartment 84 accommodating the sample separation unit 30. Thus, the second thermal impact unit 82 will also control temperature of the sample separation unit 30. The above-mentioned control unit 70 may be configured for controlling the thermal impact units 80, 82 for thermally impacting the fluidic sample and/or the mobile phase and for separately thermally impacting the sample separation unit 30 independently from each other. Highly advantageously, thermal impact assembly 100 may thus be configured for thermally impacting the fluidic sample and/or the mobile phase on the one hand and the sample separation unit 30 on the other hand individually and, if desired, differently. This introduces a further degree of freedom or design parameter which can be used for refining temperature adjustment. For instance, another target temperature may be set for the fluidic sample and the mobile phase as compared to the sample separation unit 30. In particular, thermally impacting the fluidic sample and/or the mobile phase may be carried out by adjusting (for instance regulating) a temperature of the fluidic sample and/or the mobile phase. Independently thereof, thermally impacting the sample separation unit 30 may be accomplished by adjusting (for example regulating) a temperature of the sample separation unit 30.

Additionally or alternatively, this additional degree of freedom may be used for emulating execution of a sample separation method developed for another sample separation apparatus (not shown in FIG. 1) on the sample separation apparatus 10 which thereby mimics operation of or behaves like the other sample separation apparatus when carrying out the sample separation method. In other words, it may be possible to control the thermally impacting for simulating execution of a separation method of another sample separation apparatus (see reference sign 110 in FIG. 9) by the sample separation apparatus 10 so that the sample separation apparatus 10 behaves like the other sample separation apparatus in terms of thermally impacting the fluidic sample and/or the mobile phase and of the sample separation unit 30.

It should be mentioned that, in the shown embodiment, the control unit 70 for controlling the thermal impact units 80, 82 may be the same control unit 70 which also controls overall operation of sample separation apparatus 10, as described above. In other embodiments, it is alternatively possible that the control unit 70 for controlling overall operation of the sample separation apparatus 10 may be another controller than control unit 70 controlling the thermal impact units 80, 82 independently from each other.

Detailed construction of temperature adjustment assemblies 100 according to exemplary embodiments of the invention, which may be implemented in a sample separation apparatus 10 as the one shown in FIG. 1, will be explained in the following referring to FIG. 2 to FIG. 9:

FIG. 2 is a schematic illustration of a thermal impact assembly 100 for a sample separation apparatus 10 according to an exemplary embodiment, wherein a first thermal impact unit 80 is integrated in or integrally formed with a selection valve 86 and a second thermal impact unit 82 is arranged in an interior of a thermal impact compartment 84.

The thermal impact assembly 100 according to FIG. 2 is arranged downstream of injector 40 and upstream of detector 50, as indicated by the corresponding reference signs in FIG. 2. A fluid flow direction is indicated with an arrow in FIG. 2. As shown, the thermal impact assembly 100 comprises a thermal impact device composed of first thermal impact unit 80 and second thermal impact unit 82. The thermal impact device is configured for tempering the fluidic sample and/or the mobile phase and the sample separation unit 30. More specifically, first thermal impact unit 80 heats (or cools) the fluidic sample and/or the mobile phase when flowing through the first thermal impact unit 80. Independently thereof, second thermal impact unit 82 heats (or cools) three parallel sample separation units 30 (which may be chromatographic separation columns) being located in thermal impact compartment 84 (such as a heating oven). A person skilled in the art will understand that the number of three parallel sample separation units 30 is just an example and that other exemplary embodiments may use a smaller (one or two) or larger (four or more) parallel sample separation units 30. Hence, the number of parallel sample separation units 30 can be any number (and may for instance be only two). Thereby, thermally pre-treating solvents and sample may be controlled or adjusted independently of thermally impacting the separation columns. Thereby, an independent control of the temperature of the separation column and of a temperature of the mobile phase and fluidic sample may be made possible. Controlled by control unit 70, the first thermal impact unit 80 may supply thermal energy to the mobile phase or fluidic sample (for heating) or may remove thermal energy from the mobile phase or fluidic sample (for cooling). Correspondingly and controlled by control unit 70 as well, the second thermal impact unit 82 may supply thermal energy to the sample separation units 30 (for heating) or may remove thermal energy from the sample separation units 30 (for cooling). Thus, each of the thermal impact units 80, 82 may be configured as a heat source and/or as a heat sink. Correspondingly, each of the thermal impact units 80, 82 may comprise a heat exchanger thermally coupled with fluidic sample or mobile phase (in case of first thermal impact unit 80) or the sample separation units 30 (in case of second thermal impact unit 82). For instance, each of the thermal impact units 80, 82 may be a heat block or a cool block.

The control unit 70, which may for instance be a correspondingly programmed or programmable processor, may be configured for controlling each of the thermal impact units 80, 82 separately and individually for thermally impacting the fluidic sample and/or the mobile phase or for thermally impacting the sample separation units 30, respectively, independently from each other. In particular, the first thermal impact device 80 in combination with the control unit 70 may be configured for setting another target temperature or temperature profile for the fluidic sample and/or the mobile phase as compared to a target temperature or temperature profile of the sample separation units 30 which may be defined by the second thermal impact unit 82 in collaboration with control unit 70. Thus, the control unit 70 may be configured for controlling the first thermal impact unit 80 and the second thermal impact unit 82 separately. For this purpose, the control unit 70 may apply different control signals 71, 73 to the first thermal impact unit 80 compared to the second thermal impact unit 82.

For instance, any of the first thermal impact unit 80 and the second thermal impact unit 82 may be a heated or cooled bulk body (such as a heating or cooling block, for instance a heating or cooling plate), for instance heated or cooled by heating or cooling fluids (such as a hot or cool gas or liquid). It is also possible that any of the first thermal impact unit 80 and the second thermal impact unit 82 may be heated by an electric current, in terms of ohmic heating. When configured as a Peltier element, the first thermal impact unit 80 and the second thermal impact unit 82 may selectively cool or heat depending on the flowing direction of a current applied to the Peltier element. Thus, the thermal impact units 80, 82 may be configured for heating, cooling, or selectively heating or cooling the fluidic sample and/or the mobile phase and/or the sample separation unit 30.

For example, the first thermal impact unit 80 may be thermally decoupled from the second thermal impact unit 82. This may promote an independent control of the thermal impact units 80, 82. Such a thermal decoupling may for instance be achieved by a sufficient spatial distance between the first thermal impact unit 80 and the second thermal impact unit 82 and/or by arranging a thermally insulating structure (not shown) between the first thermal impact unit 80 and the second thermal impact unit 82.

As shown, three sample separation units 30 (for instance three different types of chromatographic separation columns) may be connected in parallel in an interior of the thermal impact compartment 84 (such as a column oven). According to FIG. 2, the first thermal impact unit 80 is arranged upstream of the second thermal impact unit 82. Thermal impact compartment 84 is used for accommodating the second thermal impact unit 82 and the sample separation units 30 therein. In other words, second thermal impact unit 82 configured for thermally impacting the sample separation units 30 is arranged inside of the thermal impact compartment 84.

Furthermore, the first thermal impact unit 80 configured for thermally impacting the fluidic sample and/or the mobile phase is arranged upstream of the thermal impact compartment 84. As shown in FIG. 2, the thermal impact assembly 100 comprises a fluidic selection valve 86 upstream of the thermal impact compartment 84 and configured for selecting one of the sample separation units 30, for instance in accordance with the requirements of a specific separation application. Mobile phase and/or fluidic sample provided at the inlet of the selection valve 86 is directed to a selected one of the outlets of the selection valve 86 selected in accordance with the switching state of the selection valve 86. In other words, depending on the switching position of the selection valve 86, mobile phase and/or fluidic sample flowing from the injector 40 may be directed into one of the three parallel fluid paths inside of the thermal impact compartment 84 so as to flow through a selected one of the three sample separation units 30. Advantageously, the first thermal impact unit 80 is integrated in or directly connected to the selection valve 86 according to FIG. 2. Hence, the column selection valve 86 may be configured as heating and/or cooling element for heating and/or cooling the mobile phase and/or fluidic sample. This keeps the thermal impact assembly 100 compact and the temperature adjustment in the first thermal impact unit 80 and in the second thermal impact unit 82 spatially close together. As a result, it may be possible to efficiently suppress artifacts resulting from an undesired temperature equilibration of the mobile phase or the fluidic sample flowing through the conduits of the thermal impact assembly 100 according to FIG. 2.

FIG. 3 is a schematic illustration of a thermal impact assembly 100 for a sample separation apparatus 10 according to an exemplary embodiment, wherein a first thermal impact unit 80 is arranged in a head portion of sample separation units 30 and a second thermal impact unit 82 is arranged in an interior of a thermal impact compartment 84.

The embodiment of FIG. 3 differs from the embodiment of FIG. 2 in particular in that, according to FIG. 3, the first thermal impact unit 80 and the second thermal impact unit 82 are arranged in a spatially overlapping manner. It is also possible that the second thermal impact unit 82 encloses or encompasses the first thermal impact unit 80. Both the first thermal impact unit 80 and the second thermal impact unit 82 may be arranged in the interior of the thermal impact compartment 84 according to FIG. 3.

In this embodiment, the first thermal impact unit 80 configured for thermally impacting the fluidic sample and/or the mobile phase is thermally coupled to a head portion of the sample separation units 30. The fluidic sample and the mobile phase flow into a respective sample separation unit 30 at the head portion. In other words, the first thermal impact unit 80 heats or cools the mobile phase or fluidic sample when flowing through the column head of the sample separation units 30. It may be advantageous that the first thermal impact unit 80 is arranged as close as possible to the column head in order to precisely control the sample temperature during separation. Thus, the sample temperature is particularly critical at the head portion of the sample separation units 30, since the actual separation process (absorption and desorption) occurs at this position.

FIG. 4 is a schematic illustration of a thermal impact assembly 100 for a sample separation apparatus 10 according to an exemplary embodiment, wherein a first thermal impact unit 80 is arranged between a selection valve 86 and a thermal impact compartment 84, whereas a second thermal impact unit 82 is arranged in an interior of a thermal impact compartment 84.

The embodiment of FIG. 4 differs from the embodiment of FIG. 3 in particular in that, according to FIG. 4, the first thermal impact unit 80 is arranged downstream of the selection valve 86 and upstream of the thermal impact compartment 84. More specifically, the first thermal impact unit 80 may thermally influence mobile phase and fluidic sample when flowing through conduits connecting selection valve 86 with thermal impact compartment 84.

In the configuration according to FIG. 4, the first thermal impact unit 80 and the second thermal impact unit 82 are very close together and close to the actual separation position of the fluidic sample while the independent controllability of the thermal impact units 80, 82 is further promoted by their spatial separation.

FIG. 5 is a schematic illustration of a thermal impact assembly 100 for a sample separation apparatus 10 according to an exemplary embodiment, wherein a first thermal impact unit 80 is arranged upstream of a selection valve 86 and a second thermal impact unit 82 is arranged in an interior of a thermal impact compartment 84.

The embodiment of FIG. 5 differs from the embodiment of FIG. 4 in particular in that, according to FIG. 5, the first thermal impact unit 80 is arranged downstream of the injector 40 and upstream of the selection valve 86.

This configuration has the advantage that the first thermal impact unit 80 may be constructed in a highly compact way since its acts on the mobile phase or the fluidic sample before splitting the flow path into multiple parallel paths by the selection valve 86.

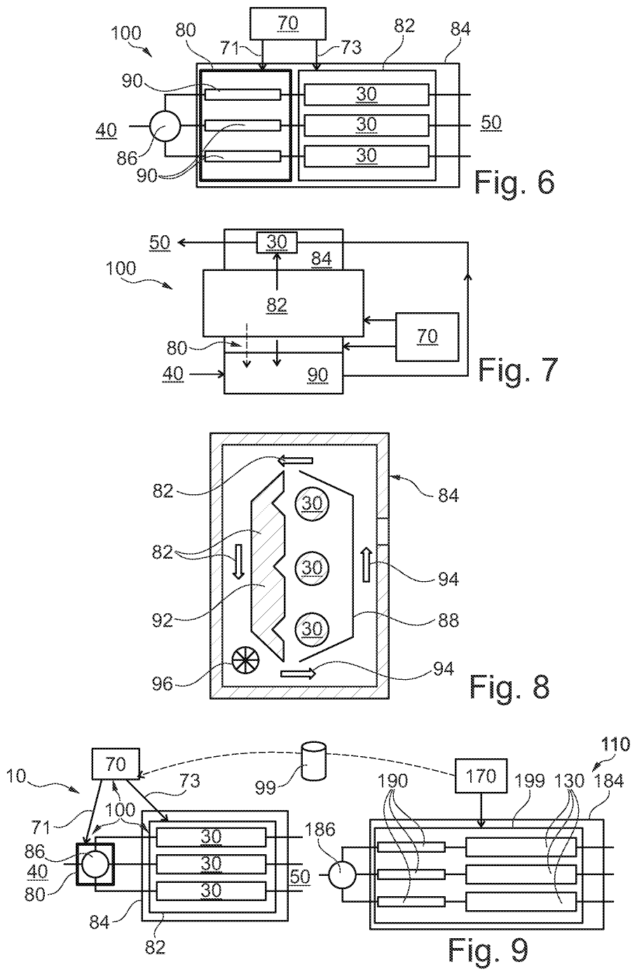

FIG. 6 is a schematic illustration of a thermal impact assembly 100 for a sample separation apparatus 10 according to an exemplary embodiment, wherein a first thermal impact unit 80 is arranged in an interior of a thermal impact compartment 84 and a second thermal impact unit 82 is arranged in the interior of the thermal impact compartment 84 as well. However, thermal impact units 80, 82 are provided in a non-overlapping way according to FIG. 6.

In the embodiment of FIG. 6, three pre-treating assemblies 90 for preheating the fluidic sample and/or the mobile phase are provided. The pre-treating assemblies 90 are accommodated in parallel flow paths in an interior of thermal impact compartment 84. For each sample separation unit 30 and thus for each of the parallel flow paths selectable by selection valve 86, an assigned pre-treating assembly 90 may be provided. Each pre-treating assembly 90 may closely surround in a thermally conductive manner a respective capillary carrying mobile phase or fluidic sample in an interior thereof. The pre-treating assemblies 90 are heated or cooled by first thermal impact unit 80, being arranged in an interior of thermal impact compartment 84 as well, under control of control unit 70. The pre-treating assemblies 90 as well as the first thermal impact unit 80 are arranged upstream of the sample separation units 30. First thermal impact unit 80 is configured for thermally impacting the fluidic sample and the mobile phase and is thermally coupled for this purpose with the pre-treating assemblies 90.

Downstream of the thermal pre-treating assemblies 90 and therefore downstream of the first thermal impact unit 80, the second thermal impact unit 82 being thermally coupled with the parallel arranged sample separation units 30 is arranged, also accommodated within thermal impact compartment 84.

FIG. 7 is a schematic illustration of a thermal impact assembly 100 for a sample separation apparatus 10 according to an exemplary embodiment, wherein a first thermal impact unit 80 for thermally impacting a fluidic sample and/or a mobile phase and a second thermal impact unit 82 for thermally impacting the fluidic sample and/or the mobile phase and for thermally impacting a sample separation unit 30 are provided.

According to FIG. 7, the fluidic sample and/or the mobile phase can be tempered by both the first thermal impact unit 80 and additionally and independently also by the second thermal impact unit 82. More specifically, the fluidic sample and/or the mobile phase are arranged to be tempered directly by the first thermal impact unit 80 (for instance as a consequence of a direct physical contact between the first thermal impact unit 80 and a pre-treating assembly 90 surrounding a conduit through which the fluidic sample and the mobile phase flow) and indirectly (for instance spaced by the first thermal impact unit 80, as shown in FIG. 7) by the second thermal impact unit 82. For instance, the fluidic sample and/or the mobile phase may be heated by the second thermal impact unit 82 in terms of a coarse temperature control and can be selectively further heated or cooled by the first thermal impact unit 80 in terms of a fine-tuning of the temperature. In contrast to this, the sample separation unit 30, which may be arranged in thermal impact compartment 84, may be tempered only by the second thermal impact unit 82. Again, control unit 70 may independently or separately or individually control the tempering functionality of the first thermal impact unit 80 and of the second thermal impact unit 82.

In the embodiment of FIG. 7, the first thermal impact unit 80 may be a Peltier element which may be operated by the control unit 70 selectively for heating or cooling. Furthermore, the second thermal impact unit 82 may be embodied as an ohmically heatable bulk body such as a heated block.

As shown in FIG. 7, thermal impact compartment 84 may be directly tempered by the second thermal impact unit 82. For instance, the thermal impact compartment 84, which may be embodied as column oven, may be directly thermally coupled with the second thermal impact unit 82, for instance may be mounted on a heated block.

Pre-treating assembly 90, through which a mobile phase and/or a fluidic sample may flow, may be indirectly thermally coupled with the second thermal impact unit 82 (which may be embodied as a heated block). As shown, the first thermal impact unit 80 (in particular a Peltier element) may be arranged sandwiched between the second thermal impact unit 82 and the pre-treating assembly 90. As a result, a majority of the thermal energy for thermally impacting pre-treating assembly 90 may be provided by the second thermal impact unit 82, whereas the fine-tuning of the thermally impacting of the pre-treating assembly 90 may be accomplished by the first thermal impact unit 80. For instance, the latter may increase or decrease the temperature of the pre-treating assembly 90 by correspondingly controlling a Peltier element. Thereby, the described configuration and independent controllability of the thermal impact units 80, 82 may allow for an efficient temperature control with high flexibility.

FIG. 8 is a schematic illustration of part of a thermal impact assembly 100 in a heating compartment 84 of a sample separation apparatus 10 according to an exemplary embodiment, wherein sample separation units 30 are heated by an only indirectly operating convection mechanism 96.

According to FIG. 8, parallel connected sample separation units 30 (which may be embodied as chromatographic separation columns extending perpendicular to the paper plane of FIG. 8) are accommodated in an interior of thermal impact compartment 84. A circumferential gas flow is created in an exterior of the thermal impact compartment 84 by a schematically illustrated convection mechanism 96. However, a resulting gas convection 94 only acts indirectly on the sample separation units 30 for thermally impacting them without exerting the sample separation units 30 to a direct gas flow. This is accomplished according to FIG. 8 by surrounding the sample separation units 30 with a thermally conductive enclosure separating the sample separation units 30 from gas convection 94. The thermally conductive enclosure is composed of a heat exchanger 92 and a flow shielding structure 88.

Therefore, the embodiment of FIG. 8 shows a configuration of the second thermal impact unit 82 enabling thermally impacting of parallel connected sample separation units 30 without gas convection 94 acting directly on the sample separation units 30. In contrast to gas convection 94 acting directly on the sample separation units 30, the second thermal impact unit 82 is configured according to FIG. 8 for thermally impacting the sample separation units 30 with gas convection 94 acting indirectly on the sample separation unit 30. This can be accomplished by providing convection mechanism 96 for creating the gas convection 94 to be thermally coupled with the sample separation units 30, while the thermally conductive shielding structure 88 shields or spaces the gas convection 94 with respect to the sample separation units 30. Moreover, the thermally conductive shielding structure 88 comprises heat exchanger 92 configured for promoting heat exchange between the gas convection 94 and the sample separation unit 30. Heat exchanger 92 may also be used for directly heating the sample separation units 30. In addition, an indirect convection flow which is shielded with respect to the sample separation units 30 may further promote proper heating of the sample separation units 30. However, it has been found that the performance of the HPLC may be improved when the sample separation units 30 are prevented from being in direct contact with the convection flow, since this may suppress formation of a pronounced temperature profile between an interior and an exterior of the column-shaped sample separation units 30. Descriptively speaking, this shielding may calm down the gas flow around the sample separation units 30, thereby improving the separation performance.

As shown, isolation walls of the thermal impact compartment 84 (which may also be denoted as column compartment) are provided as an exterior casing. Reference sign 92 denotes the heat exchanger, heater, cooler of the system. FIG. 8 shows a cross section of the sample separation units 30 (embodied as HPLC columns). Reference sign 88 indicates an air flow diversion shield or flow diverted shield. The arrows in FIG. 8 show the forced air flow or gas convection 94.

Advantageously, shielding structure 88 may be mechanically coupled with a door (not shown) of thermal impact compartment 84 so that opening such a door by a user may automatically expose the sample separation units 30 without the need to disassemble shield structure 88 separately. This ensures a user-friendly operation.

The embodiment of FIG. 8 may or may not be combined with an independently controllable first thermal impact unit 80 (for instance embodied as described referring to FIG. 1 to FIG. 7).

FIG. 9 is a schematic illustration of a thermal impact assembly 100 of a (first) sample separation apparatus 10 according to an exemplary embodiment, wherein operation of the thermal impact assembly 100 emulates a tempering behavior of another (second) sample separation apparatus 110.

For instance, the sample separation apparatus 10 may be constructed as described above referring to FIG. 1 and FIG. 2.

The other sample separation apparatus 110 may be constructed with a single common thermal impact device 199 in an interior of a column oven 184. By a column selection valve 186, one of three parallel fluidic paths may be selected, each fluidic path comprising a serial connection of a pre-heater assembly 190 and an assigned chromatographic separation column 130. Thermal impact device 199 tempers the fluidic sample and the mobile phase flowing through a respective pre-heater assembly 190 and tempers as well the sample separation units 30. The sample separation apparatus 110 may be configured for carrying out a chromatographic separation method fulfilling a very specific separation task and being configured specifically in accordance with the particularities of the sample separation apparatus 110. Such a chromatographic method may be stored in a database 99.

It may be desired under specific circumstances to carry out the chromatographic separation method developed specifically for the sample separation apparatus 110 using the other sample separation apparatus 10. However, in view of the different particularities of the sample separation apparatuses 10, 110, carrying out the chromatographic separation method developed for the sample separation apparatus 110 may yield another separation result (in particular another chromatogram) when executed on the sample separation device 110.

By specifically configuring the sample separation apparatus 10 and in particular thermal impact assembly 100 thereof, execution of the mentioned chromatographic separation method may be rendered backward compatible. Descriptively speaking, properly controlling the thermal impact units 80, 82 of sample separation apparatus 10 by control unit 70 may allow for a configuration of the sample separation apparatus 10 so as to behave—in terms of temperature adjustment—like the sample separation apparatus 110 upon executing the chromatographic separation method. In other words, what concerns pre-heating, the additional degree of freedom of adjusting thermal impact units 80, 82 separately or independently in sample separation apparatus 10 allows to operate the sample separation apparatus 10 for carrying out the chromatographic separation method developed for sample separation apparatus 110 for emulating the behavior of the sample separation apparatus 110.

For this purpose, the control unit 70 may be configured for controlling each of the thermal impact units 80, 82 individually so that execution of the separation method on the sample separation apparatus 10 emulates operation of the other sample separation apparatus 110 what concerns thermally impacting the fluidic sample and/or the mobile phase and of the sample separation units 30. For controlling thermal impact units 80, 82, the control unit 70 may determine and apply a transfer function describing operation of thermal impact units 80, 82 so as to behave like thermal impact device 199 of sample separation apparatus 110 in terms of temperature control. Thus, the control unit 70 may be configured for emulating operation of the other sample separation apparatus 110 based on the transfer function determined so that the sample separation apparatus 10 behaves, in particular in terms of thermally impacting the fluidic sample and/or the mobile phase and of the sample separation unit 30, like the other sample separation apparatus 110 when carrying out the separation method (which has been initially developed for the other sample separation apparatus 110) on the sample separation apparatus 10. The additional degree of freedom or design parameter in form of the independently controllable second thermal impact unit 82 in addition to the independently controllable first thermal impact unit 80 may be advantageously used for providing the described emulation function.

Further advantageously, emulating the temperature control behavior of sample separation apparatus 110 by correspondingly controlling sample separation apparatus 10 may be synergistically combined with an emulation of the time dependence of a solvent composition of the mobile phase (in particular in terms of a gradient run) of sample separation apparatus 110 when executing the developed separation method on sample separation apparatus 10. For this purpose, a target time dependence of the solvent composition according to the chromatographic separation method developed for sample separation apparatus 110 may be transferred into a modified time dependence (by correspondingly modifying operation of fluid drive unit 20 in combination with solvent supply 25) so that sample separation apparatus 10, when carrying out the modified or adapted separation method, behaves as sample separation apparatus 110 also in terms of the time dependence of the solvent composition of the mobile phase. By taking this measure, method transfer from sample separation system 110 to sample separation system 10 may be rendered highly accurate.

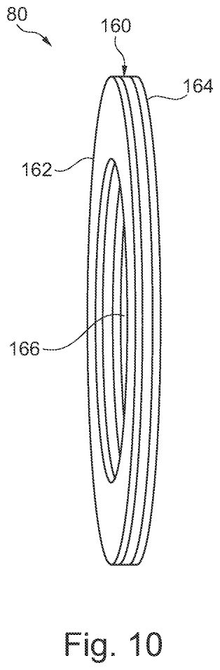

FIG. 10 is a three-dimensional view of a first thermal impact unit 80 for a thermal impact assembly 100 of a sample separation apparatus 10 according to an exemplary embodiment. The illustrated first thermal impact unit 80 is configured as a Metal-Micro-Fluidic (MMF) structure for heating or cooling a mobile phase and/or a fluidic sample and being provided to be integrated in a channel selection valve, such as fluidic selection valve 86 shown in FIG. 2 or FIG. 9.

The mentioned thermal impact unit 80 can comprise a plurality of metal structures connected by thermal bonding at high pressure and high temperature and made for example from stainless steel foils. More specifically, the illustrated thermal impact unit 80 is an annular structure 160 of interconnected metal foils, comprising an MMF heater 162 and an MMF cooler 164 and having a central through hole 166. Heating or cooling the channel selection valve 86 may be carried out by the annular structure 160 as a pre-column liquid conditioner.

Conventional column compartments need a solvent heater/cooler per column, this impacts the efforts for manufacturing the instrumentation. Those conventional devices are also located inside the compartment impacting the temperature stability of the environment surrounding the columns.

In contrast to such conventional approaches, the embodiment of FIG. 10 embeds a precolumn heater in the selection valve 86 using MMF technology. With the use of one or more plasma heaters (the name comes from the manufacturing technology) and one or more Peltier heaters packaged together with an MMF (Metal-Micro-Fluidics) in a sandwiched structure, the thermal impact unit 80 of FIG. 10 can be obtained. Hence, an integration of a thermal impact function and a valve function in one more capable device may become possible, reducing the number of components that will be required in the instruments for providing the function of pre-column heaters/coolers). Moreover, a reduction of the manufacturing effort may be achieved by replacing a plurality of (for example eight) pre-column heaters by one. The described embodiment also provides heating capabilities outside of the column compartments. The liquid may get a thermal impact before it gets inside the compartments avoiding condensation problems and temperature instabilities inside. Advantageously, a significant space reduction in the compartments may be obtained. Preferably, it may be possible to create a sandwiched structure, as per FIG. 10, packing a cooler and a plasma heater in an MMF structure, most preferably in the head of the column selection valve 86.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

1. A thermal impact assembly for a sample separation apparatus for separating a fluidic sample in a mobile phase by a sample separation unit, the thermal impact assembly comprising:
a thermal impact device configured to thermally impact the fluidic sample and/or the mobile phase and the sample separation unit; and
a control unit configured to control the thermal impact device for thermally impacting the fluidic sample and/or the mobile phase on the one hand and for thermally impacting the sample separation unit on the other hand independently from each other.

2. The thermal impact assembly according to claim 1, wherein the thermal impact device comprises a first thermal impact unit configured to thermally impact the fluidic sample and/or the mobile phase and comprises a second thermal impact unit configured to thermally impact the sample separation unit.

3. The thermal impact assembly according to claim 2, comprising at least one of the following features:
wherein the first thermal impact unit is thermally and/or functionally decoupled from the second thermal impact unit;
wherein the control unit is configured to control the first thermal impact unit and the second thermal impact unit separately by separate control signals.

4. The thermal impact assembly according to claim 2, wherein the fluidic sample and/or the mobile phase is controlled to be tempered by the first thermal impact unit and additionally by the second thermal impact unit.

5. The thermal impact assembly according to claim 4, comprising at least one of the following features:
wherein the fluidic sample and/or the mobile phase is arranged to be tempered directly by the first thermal impact unit and indirectly by the second thermal impact unit;
wherein the fluidic sample and/or the mobile phase is arranged to be heated by the second thermal impact unit and selectively further heated or cooled by the first thermal impact unit.

6. The thermal impact assembly according to claim 2, comprising at least one of the following features:
wherein the sample separation unit is arranged to be tempered by the second thermal impact unit only;
wherein the first thermal impact unit is arranged upstream of the second thermal impact unit;
wherein the first thermal impact unit and the second thermal impact unit are arranged in a spatially overlapping manner;
wherein the first thermal impact unit is arranged within the second thermal impact unit;
wherein at least one of the first thermal impact unit or the second thermal impact unit comprises at least one selected from the group consisting of: a heatable or coolable bulk body; a Peltier element; and a plasma heater;
wherein the second thermal impact unit is configured for thermally impacting the sample separation unit without gas convection acting directly on the sample separation unit.

7. The thermal impact assembly according to claim 2, wherein the second thermal impact unit is configured for thermally impacting the sample separation unit with gas convection acting indirectly on the sample separation unit by providing:
a convection mechanism for creating the gas convection for promoting thermal coupling of the sample separation unit; and
an at least partially thermally conductive shielding structure shielding the gas convection (94) from the sample separation unit;
wherein the at least partially thermally conductive shielding structure comprises a heat exchanger configured for promoting heat exchange between the gas convection and the sample separation unit.

8. The thermal impact assembly according to claim 1, wherein the control unit is configured to control the thermal impact device so that operation of the sample separation apparatus emulates operation of another sample separation apparatus, in terms of thermally impacting the fluidic sample and/or the mobile phase and in terms of thermally impacting the sample separation unit, wherein the control unit is configured to emulate operation of the other sample separation apparatus based on a transfer function determined so that the sample separation apparatus behaves, in terms of thermally impacting the fluidic sample and/or the mobile phase and in terms of thermally impacting the sample separation unit, like the other sample separation apparatus when carrying out a separation method developed for the other sample separation apparatus on the sample separation apparatus.

9. The thermal impact assembly according to claim 1, wherein the thermal impact device is configured for heating, cooling, or selectively heating or cooling the fluidic sample and/or the mobile phase and/or the sample separation unit.

10. A sample separation apparatus for separating a fluidic sample, the sample separation apparatus comprising:
a fluid drive unit configured for driving a mobile phase and the fluidic sample injected in the mobile phase;
a sample separation unit configured for separating the fluidic sample in the mobile phase; and
a thermal impact assembly according to claim 1 for thermally impacting the fluidic sample and/or the mobile phase on the one hand and the sample separation unit on the other hand independently from each other.

11. The sample separation apparatus according to claim 10, comprising a thermal impact compartment in which the sample separation unit is arranged.

12. The sample separation apparatus according to claim 11, wherein a first thermal impact unit configured for thermally impacting the fluidic sample and/or the mobile phase is arranged upstream of the thermal impact compartment.

13. The sample separation apparatus according to claim 10, comprising at least one further sample separation unit connected in parallel to the sample separation unit and comprising a selection valve configured for selecting one of the sample separation units.

14. The sample separation apparatus according to claim 12, comprising one of the following features:
wherein the first thermal impact unit is integrated in the selection valve;
wherein the first thermal impact unit comprises a Metal-Micro-Fluidic structure integrated in the selection valve;
wherein the first thermal impact unit is arranged between the selection valve (86) and the thermal impact compartment;
wherein the first thermal impact unit is arranged upstream of the selection valve.

15. The sample separation apparatus according to claim 11, wherein a first thermal impact unit configured for thermally impacting the fluidic sample and/or the mobile phase is arranged at least partially inside of the thermal impact compartment and is thermally coupled to a head portion of the sample separation unit.

16. The sample separation apparatus according to claim 10, comprising a pre-treating assembly for thermally pre-treating the fluidic sample and/or the mobile phase upstream of the sample separation unit, wherein a first thermal impact unit configured for thermally impacting the fluidic sample and/or the mobile phase is thermally coupled with the pre-treating assembly.

17. The sample separation apparatus according to claim 11, wherein a second thermal impact unit configured for thermally impacting the sample separation unit is arranged at least partially inside of the thermal impact compartment.

18. The sample separation apparatus according to claim 10, further comprising at least one of the following features:
the sample separation apparatus is configured as a chromatography sample separation apparatus;
an injector configured to inject the fluidic sample into the mobile phase;
a detector configured to detect the separated fluidic sample;
a fractioner unit configured to collect the separated fluidic sample;
a degassing apparatus for degassing at least part of the mobile phase.

19. A process of adjusting a temperature of a fluidic sample and/or a mobile phase and of a sample separation unit in a sample separation apparatus, the process comprising:
thermally impacting the fluidic sample and/or the mobile phase and the sample separation unit; and
controlling the thermally impacting so as to thermally impact the fluidic sample and/or the mobile phase on the one hand and to thermally impact the sample separation unit on the other hand independently from each other.

20. The process according to claim 19, comprising at least one of the following features:
wherein the method comprises controlling a first thermal impact unit for thermally impacting the fluidic sample and/or the mobile phase independently of thermally impacting the sample separation unit, and separately controlling a second thermal impact unit for thermally impacting the sample separation unit independently of thermally impacting the fluidic sample and/or the mobile phase;
wherein the method comprises controlling the thermally impacting for simulating execution of a separation method of another sample separation apparatus by the sample separation apparatus so that the sample separation apparatus behaves like the other sample separation apparatus, in terms of thermally impacting the fluidic sample and/or the mobile phase and in terms of thermally impacting the sample separation unit;
wherein the method comprises thermally impacting the fluidic sample and/or the mobile phase by adjusting a temperature of the fluidic sample and/or the mobile phase and/or comprises thermally impacting the sample separation unit by adjusting a temperature of the sample separation unit.
